(19) United States
(12) Patent Application Publication
(10) Pub. No.: US 2004/0221024 A1
(43) Pub. Date: Nov. 4, 2004

(54) Apparatus and method for setting environment of client in client / server system, and program recording medium therefor

(76) Inventors: Katsuya Yamada, Kawasaki (JP); Masanori Suzuki, Kawasaki (JP)

Correspondence Address: STAAS & HALSEY LLP, SUITE 700, 1201 NEW YORK AVENUE, N.W., WASHINGTON, DC, 20005, US

(21) Appl. No.: 09/811,584

(22) Filed: Mar. 20, 2001

(30) Foreign Application Priority Data
Nov. 16, 2000 (JP) 2000-349873

(51) Int. Cl. G06F 9/455; G06F 15/177

(52) U.S. Cl. 709/222

(57) ABSTRACT

The present invention is directed to an apparatus enabled to easily and automatically restore the environment of a client in a client/server system after a hard disk of the client is replaced with a new one. This apparatus has a unit recognizing that replacement of a hard disk of a client (200) is performed, and another unit that installs data, which is backed up from the hard disk provided in the client before the replacement thereof and subsequently and preliminarily stored in a server (100), in response to the replacement thereof onto a hard disk provided in the client after the replacement. Further, a plurality of kinds of data backed up from the hard disk, which is provided in the client before the replacement thereof, are prepared in the server. One of the plurality of kinds of data can be selected therefrom and installed on the hard disk that is provided in the client. For example, one of the plurality of kinds of data may be backed up from the hard disk of the client in the environment just before the replacement of the hard disk is performed therein.

### BACKGROUND OF THE INVENTION

1. Field of the Invention

The present invention generally relates to an apparatus and method for setting the environment of a client in a client/server system, and to a program recording medium therefor. More particularly, the present invention relates to an apparatus and method for easily and automatically restoring the environment of a client in a client/server system after replacing a hard disk in a client, and to a program recording medium for storing a program therefor.

2. Description of the Related Art

Various capabilities allowing a server to manage clients in a client/server system, which comprises clients, such as personal computers, and a server adapted to provide resources to and to manage such clients, have been devised. For example, the environment of a client is constructed by installing software programs one by one onto the client, which operates in a standalone mode, or by selecting software programs, which are to be installed onto the client, from among those stored in a server and then installing the selected software program onto the client.

Recently, the following systems have been put into practical use. That is, a system in which a client is powered up according to an instruction issued by a server, a Wake on LAN (WoL) system in which a remote client is powered up by, for example, sending a packet to the client, a system in which a client is connected to a server just after being powered up, and a PXE (Preboot execution Environment) environment-based network system, in which a client of a client/server system is connected to a server thereof before an operating system is booted on the client (incidentally, in this case, it is necessary to provide a special boot ROM in a network adapter of the client).

When such a WoL system or a PXE environment-based network system is utilized in the case of installing a single software program, remote loading thereof can be achieved without performing an operation in a client.

However, in the case of installing a single software program that requires rebooting (or restarting) during installing the program (such a case includes a case of installing a plurality of such software programs), the client needs a manual user operation to be performed after the rebooting. Therefore, even when the aforementioned system is utilized, it is impossible to completely perform a remote loading operation.

A conceivable example of the case of requiring such a kind of a remote loading operation is a case in which a client goes down and the recovery thereof is needed. In this case, it is desired that the recovery of the client is entirely automatically achieved by manipulating the client by a server. The applicant of the present application, therefore, filed Japanese patent application concerning a technique of installing highly convenient software (that is, Japanese Patent Application No. 11-210078) on Jul. 7, 1999. More particularly, this technique realizes a remote loading operation that enables the setting of the environment of a client in a client/server system by automatically installing software according to an instruction from a server even when the server prepares the entire operating environment of the client and the software requires rebooting during the installation.

However, the remote loading technique disclosed in the aforementioned Japanese Patent Application No. 11-210078 requires that an administrative operator or a user should replace a hard disk when the hard disk of a client physically breaks and that, subsequently, because information on the environment of the client, which is stored in the hard disk used before it was replaced with a new one, is unknown, the administrative operator should restore the environment of the client by manipulating the client from a server through a management console. Thus, the aforementioned remote loading technique requires manual operations performed at two places, that is, the management console and the client. Therefore, this technique has a drawback in that the environment of a client cannot be easily and automatically restored after a hard disk of the client is replaced with a new one.

### SUMMARY OF THE INVENTION

Accordingly, an object of the present invention is to eliminate the drawback, and to provide an apparatus and method for setting the environment of a client in a client/server system, which are enabled to easily and automatically restore the environment of the client without an administrative operator's manipulation thereof from a server after the client is powered up upon completion of replacing a hard disk of the client with a new one, or after the client is automatically powered up by being manipulated from a server performing a WoL function, and to provide a program recording medium for storing a program therefor.

To achieve the foregoing object, according to an aspect of the present invention, there is provided an apparatus for setting the environment of a client in a client/server system, which comprises a unit recognizing that replacement of a hard disk of a client is performed, and a unit that installs data, which is backed up from the hard disk provided in the client before the replacement thereof and subsequently and preliminarily stored in a server, in response to the replacement thereof onto a hard disk provided in the client after the replacement thereof.

In this apparatus for setting the environment of a client in a client/server system, it is preferable that a plurality of kinds of data are prepared in the server as the backed-up data, that one of the plurality of kinds of data is selected, and that the selected one kind of data is then installed in the client.

In this apparatus for setting the environment of a client in a client/server system, preferably, the selected kind one of data is data backed up in the environment just before the replacement.

Alternatively, in this apparatus for setting the environment of a client in a client/server system, preferably, the selected kind one of data is data backed up in the environment at the time of initially setting the client.

In this apparatus for setting the environment of a client in a client/server system, preferably, an application program included in the data, which is backed up in the environment at the time of initially setting the client, is updated to the latest version thereof until the replacement of the hard disk.

In this apparatus for setting the environment of a client in a client/server system, preferably, the server has a unit keeping a log of processing performed on the client.

In this apparatus for setting the environment of a client in a client/server system, preferably, the client periodically sends document data to the server.

To achieve the foregoing object, according to another aspect of the present invention, there is provided a method for setting the environment of a client in a client/server system, which comprises the step of recognizing that replacement of a hard disk of a client is performed, and the step of installing data, which is backed up from the hard disk provided in the client before the replacement and subsequently and preliminarily stored in a server, in response to the replacement onto a hard disk provided in the client after the replacement.

To achieve the foregoing object, according to still another aspect of the present invention, there is provided a computer readable program recording medium for recording a program causing a computer to set the environment of a client in a client/server system. This medium records a program causing a computer to perform the step of recognizing that replacement of a hard disk of a client is performed, and the step of installing data, which is backed up from the hard disk provided in the client before the replacement and subsequently and preliminarily stored in a server, in response to the replacement onto a hard disk provided in the client after the replacement.

Thus, the apparatus and method of the present invention for setting the environment of a client in a client/server system, and the program recording medium of the present invention enable the system to easily and automatically restore the environment of a client after the replacement of a hard disk is performed.

### BRIEF DESCRIPTION OF THE DRAWINGS

Other features, objects and advantages of the present invention will become apparent from the following description of preferred embodiments with reference to the drawings in which like reference characters designate like or corresponding parts throughout several views, and in which:

FIG. 1 is a schematic block diagram illustrating the constitution of an apparatus for setting the environment of a client in a client/server system according to an embodiment of the present invention;

FIG. 2 is a schematic block diagram illustrating the constitution of a server shown in FIG. 1;

FIG. 3 is a schematic block diagram illustrating the constitution of a client shown in FIG. 1;

FIG. 4 is a table illustrating a database of the client, which is stored in the server;

FIG. 5 is a block diagram illustrating a procedure for setting the environment of a client in the client/server system shown in FIG. 1 during the replacement of a hard disk in the client;

FIG. 6 is a block diagram illustrating the procedure of communication between a client and a server in the client/server system shown in FIG. 1 during the replacement of a hard disk in the client;

FIG. 7 is a diagram illustrating a procedure for powering up a client in the client/server system shown in FIG. 1 by manipulating the client from a server performing a WoL function;

FIG. 8 is a diagram illustrating a procedure for downloading data, which is backed up from a hard disk, from a server to a client in the client/server system shown in FIG. 1;

FIG. 9 is a diagram illustrating operations of the client and the server shown in FIG. 8;

FIG. 10A is a perspective diagram showing the practical constitution of a client or a server for illustrating a method of installing a program recording medium, which is used in an apparatus for setting the environment of a client in a client/server system of the present invention, in the client or the server; and

FIG. 10B is a block diagram illustrating the inner constitution of the client or the server shown in FIG. 10A.

### DETAILED DESCRIPTION OF THE PREFERRED EMBODIMENTS

Hereinafter, the preferred embodiments of the present invention will be described in detail by referring to the accompanying drawings. Incidentally, like reference numerals designate like portions in the drawings.

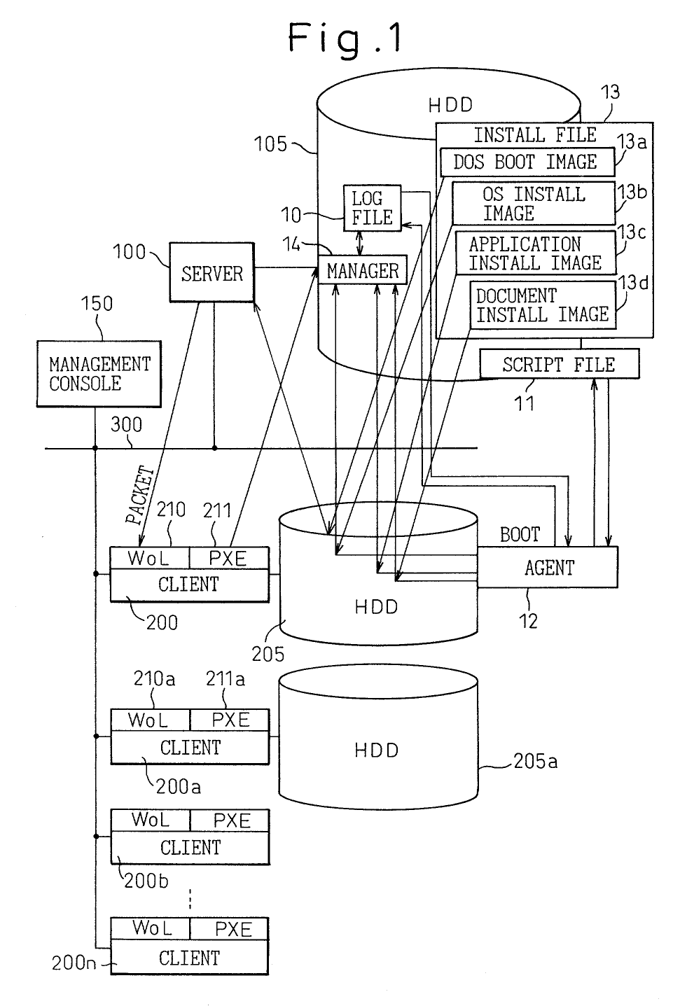

FIG. 1 is a schematic block diagram illustrating the constitution of an apparatus for setting the environment of a client in a client/server system according to an embodiment of the present invention. The server/client system shown in FIG. 1 comprises a server 100, clients 200, 200a, 200b, . . . , and 200n connected to the server 100 through a local area network (LAN) 300, and a management console 150 connected to the LAN 300 and used for manually manipulating each of the clients from the server 100. Incidentally, in the following description, it is assumed for the purpose of understanding that “the client 200” represents all the clients 200, 200a, 200b, . . . , and 200n.

The management console 150 may be incorporated into the server 100, and is used for selecting from data stored in a hard disk 105 of the server 100 backup data to be downloaded to the client 200.

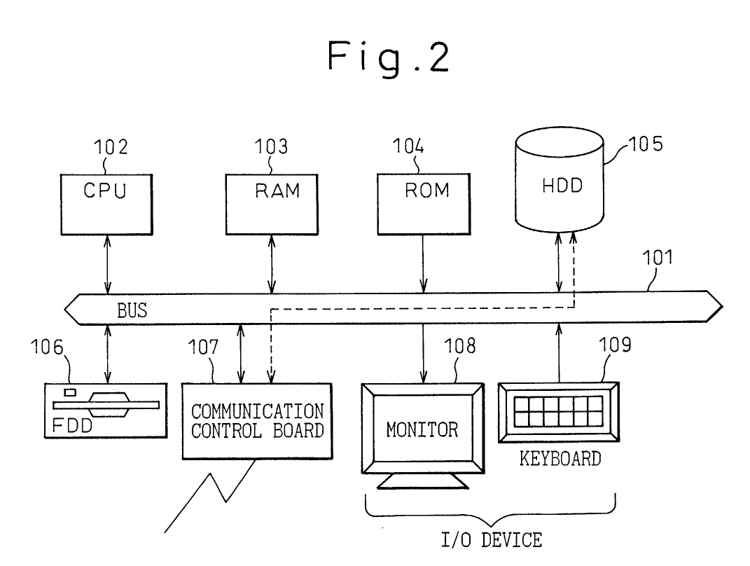

FIG. 2 is a schematic block diagram illustrating the constitution of a server shown in FIG. 1. The server 100 comprises a CPU 102, a RAM 103, a ROM 104, a HDD (had disk drive) 105, a FDD (floppy disk drive), a communication control board 107 for providing a LAN communication environment, a display unit 108, and an input device, such as a keyboard 109.

Further, in HDD 105, a management log file 10 for recording a log of the execution state of installation of a file into the client 200, a script file 11 serving as a control file containing an execution script S that is execution control information for specifying installation execution processing, an agent 12 for executing installation of a file into the client 200 according to the execution script S, an installation file 13 to be installed into the client 200 are stored.

The execution script S is definition information for setting execution instructions (that is, setup commands), which is required to install a file and read by the agent 12 in the client 200 and then executed therein. The execution script S sets the setup commands according to the order of installation files 13 to be set up.

Further, the agent 12 is an independent program for performing processing in the client 200, to which the agent 12 is downloaded, according to the execution instructions defined by the execution script S. In this embodiment, the installation file 13 is installed from the server 100 to the client 200. The agent 12 should always access the management log file 10 and check the progression state of installation in the client 200 before the installation of a file is performed. Then, the agent 12 continues to install the file according to the execution script S. Furthermore, at each completion of installation or at each request for rebooting, the agent 12 accesses the management log file 10 and updates the progression state of the installation and updates this log file 10.

The installation file 13 contains an operating system (OS) installation image file 13b of an operating system to be booted in the client 200, an application installation image file 13c of an application program to be installed to the client 200, a document installation image file 13d of a document to be similarly installed to the client 200 in addition to DOS booting image file 13a (including DOS manager (to be described later) and LAN manager (to be described later)) to be first booted in the client 200. These files are prepared in an environment setting apparatus of the client in the client/server system for initially booting the client 200 and for performing the recovery of the client after the client 200 goes down.

Moreover, in the server 100, a program to be read from the HDD 105 and executed in CPU 102 is activated. This program includes a manager 14 for managing operations of reading and writing (including updating) of the management log file 10 recorded on HDD 105 and for managing an operation of reading the script file 11.

Further, this manager 14 has a function of issuing a switching instruction (that is, a boot switch command) for switching a booting method to be performed from remote booting in the client 200 utilizing a PXE function to local booting (that is, a booting method performed by a client singly and started by reading a file stored in the hard disk thereof) at request sent from the agent 1 according to the description of the execution script S when a request for booting is issued during the installation thereof is performed in the client 200, and when a request for rebooting is issued upon completion of installation thereof in the client 200. When executing this switching instruction, the setting of a boot flag provided correspondingly to each of the clients 200 is simultaneously set in the management log file 10 (that is, “1” is set in the case of the local booting, while “0” is set in the case of the remote booting).

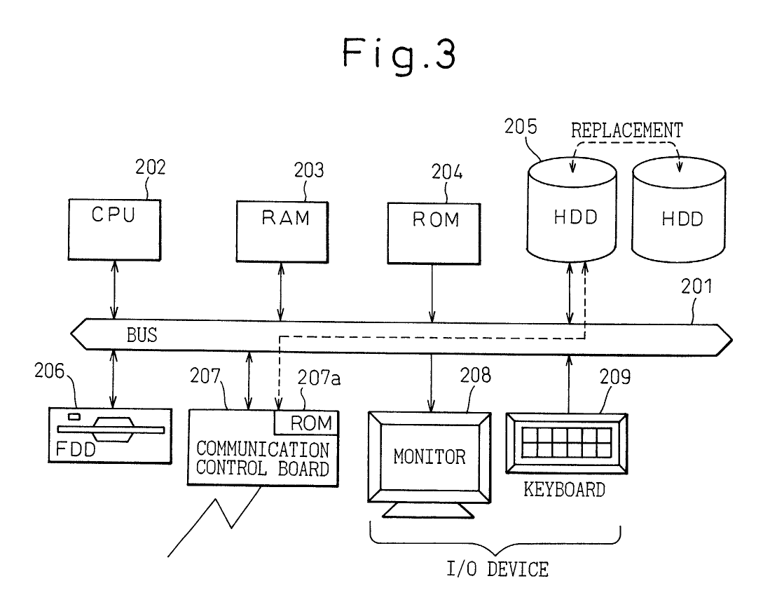

FIG. 3 is a schematic block diagram illustrating the constitution of the client shown in FIG. 1. The client 200 has a constitution nearly the same as that of the server 100. Further, the client 200 comprises CPU 202, RAM 203, ROM 204, HDDs (hard disk drives) 205, FDD (a flexible disk drive) 206, a communication control board 207 for providing LAN communication environment, a display unit 208, and an input/output device, such as a keyboard 209, which are connected to one another through a bus 201.

Furthermore, the client 200 has a Wake on LAN (WoL) feature 210 and a PXE (Preboot eXecution Environment) feature, the corresponding environment of each of which is realized by using ROM 207a mounted on the communication control board 207. This PXE feature 211 defines the order in which the methods of booting the operating system in the client 200 are selected and performed. Further, ROM 207a mounted on the communication control board 207 determines according to the setting of BIOS (Basic I/O System) of the client 200 whether or not the aforementioned functions and features are realized. Information on the setting thereof is stored in a flash memory (not shown) provided on the communication control board 207.

The WoL feature 210 has a function of powering up a target client 200 by sending a packet to the target client 200 from the server 100.

Moreover, the PXE feature 211 causes the client to be connected to the server 100 just after the client 200 is powered up. At that time, a corresponding boot flag provided in the management log file 10 of the server 100 is set at a value corresponding to the remote booting (incidentally, a default value thereof corresponds to the remote booting). The server 100 first sends a DOS boot image file 13a to the client 200. Thus, the client 200 is booted in the DOS (Disk Operating System) environment. Furthermore, when the client 200 is connected to the server 100 by LAN manager 14 in this DOS environment, the agent 12 is sent from the server 100 to RAM 203 of the client 200. Even when the operating system is in a bootable condition, the client 200 is booted by the server 100 before this operating system is booted, in the case that this PXE feature 211 is effective when the client 200 is powered up.

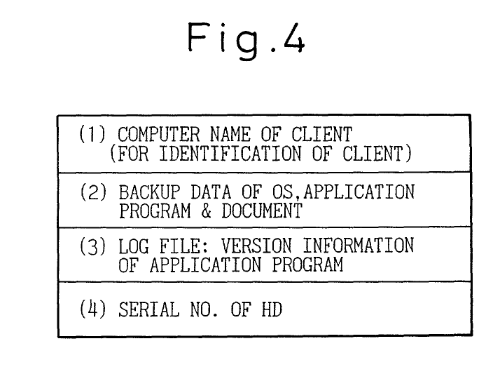

FIG. 4 is a table illustrating a database of the client, which is stored in the server. The server 100 contains a database constituted by information indicated in FIG. 4 corresponding to each of the clients 200, 200a, . . . , and 200n. This database includes (1) a computer name or an identification number for identifying each of the clients, (2) backup data representing an operating system, application programs, and documents (that is, data representing documents, bit maps, and sounds, which are created by using the application programs or obtained by being installed through a communication line), which are stored as the installation file 13, and (3) version information on the version of each of the application, which are stored as the management log file 10, and (4) information on the serial No. of the hard disk.

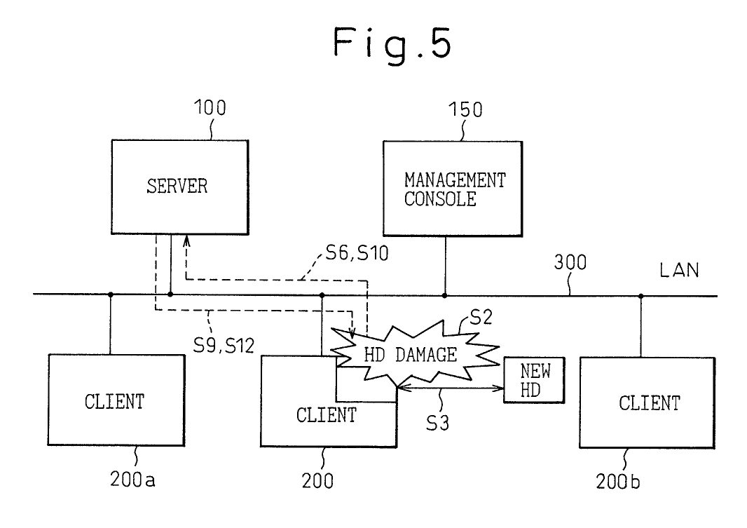

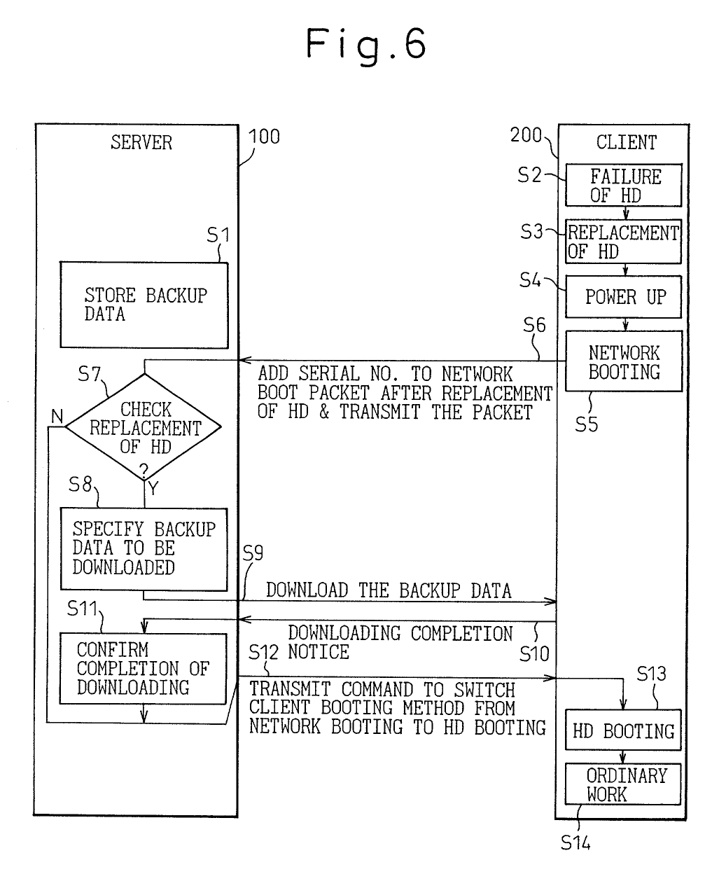

FIG. 5 is a block diagram illustrating a procedure for setting the environment of a client in the client/server system shown in FIG. 1 during the replacement of the hard disk in the client. FIG. 6 is a block diagram illustrating the procedure of communication between a client and a server in the client/server system shown in FIG. 1 during the replacement of the hard disk in the client. The restoration of the environment of a client is performed according to the following procedure indicated at steps S1 to S14 in FIGS. 5 and 6.

At step S1, backup data preliminarily and periodically obtained from the client 200 is stored in a hard disk (D).

At step S2, HD of the client is damaged.

At step S3, the damaged HD of the client 200 is replaced with a normal HD.

At step S4, the client 200 is powered up. Then, the serial No. of this normal HD is replaced with that of the damaged HD. At step S4, after the serial No. of HD is updated, the client 200 may be powered up from the server 100 by using the WoL feature instead of being powered up by an administrative operator and a user in the client 200.

At step S5, the client 200 starts the network booting by employing the PXE environment feature. That is, the PXE feature 211 is activated when the client 200 is powered up by the client 200.

At step S6-1, the client 200 sends a network boot packet, to which data representing the serial No. of the hard disk provided in the client 200 after the replacement is added, together with a request for PXE feature 211 to the server 100. The client 200 issues an IDENTIFY DEVICE command among commands defined as ATA commands during network booting. Incidentally, the term “ATA command” means a command used by a server for obtaining data, such as the serial No. of the HD, stored in BIOS of the client.

At step S6-2, the server 100 receives the data sent from the client 200 by means of the manager 14 and acquires the serial No. (indicated by ASCII codes of 20 characters) of the HD, which is represented by word bits 10 to 19 of the IDENTIFY DEVICE command.

At step S6-3, in a default mode, the boot flag of the client 200, which corresponds to the management log file 10, is set at a remote side. Thus, the manager 14 remote boots the client 200 and causes the server 100 to download a DOS boot image file 13a onto RAM 203 of the client 200. At that time, a LAN manager is also downloaded to the client 200 and booted together with DOS.

At step S6-4, in DOS environment, this LAN manager connects the client 200 to the server 100. The processing performed at these steps S6-1 to S6-4 is the remote booting processing performed by using PXE feature 211. Further, simultaneously with this remote booting, the agent 12 is downloaded from the server 100 to the RAM 203 of the client 200.

At step S7, when the serial No. of the HD of the client 200 is changed from the serial No., which is acquired before the replacement of the HD and stored in the server 100, to the serial No. acquired after the replacement of the HD and sent to the server 100, these serial Nos. do not match each other and thus, the server 100 decides that the HD of the client 200 has been replaced with a new one. Then, the server 100 performs processing at steps S8 to S11. Conversely, when these serial Nos. match with each other, the server 100 judges that the HD of the client has not been replaced with another one. Then, the server 100 performs processing at step S12.

At step S8, the sever 100 specifies the backup data to be downloaded to the client 200. This means that because a plurality of kinds of backup data are stored in the server 100, as will be described later, the server 100 selects one of the kinds of backup data to be installed to the client.

At step S9, because the server 100 recognizes that the HD of the client 200 has been replaced with another one, the server 100 downloads the backup data, which is backed up from the HD of the client 200 and specified at step S8, to the client 20 to thereby restore the environment, which was established before the replacement of the HD, of the client 200.

At step S10, the client 200 posts the downloading of the backup data, which is performed to restore the environment thereof, to the server 100.

The details of the processing performed at steps S9 and S10 will be described later with reference to the accompanying drawings.

At step S11, the server 100 confirms that the downloading of the specified data to the client 200 is completed.

At step S12, the method of booting the client 200 is switched from the network booting performed at step S5 to the booting thereof from the HD thereof. Then, the client 200 is rebooted. This means that the order, in which the methods of booting are selected and performed, is defined according to the setting of BIOS. That is, at step S5, the method of booting the OS is selected and performed in the order from the network booting to HDD booting through FDD booting. This order is changed at step S13 so that the method of booting OS is selected and performed in the order from the FDD booting to the HDD booting.

At step S13, thus, the client 200 is booted from the HD thereof.

At step S14, the client 200 starts performing ordinary work.

The aforementioned process is performed between the server 100 and the target client 200. Thus, even in the case that there are data, such as an operating system, application software programs and documents, which require rebooting the client during the installation, when the client 200 is powered up without instructions from the server 100 after the hard disk thereof is replaced with another, or when the client 200 is automatically powered up without instructions from the server 100 from the server 100 by utilizing WoL feature, thereafter, these data are automatically installed from the server 100 to the client 200. This enables the construction of the environment of the client 200 in the client/server system. Thus, in the case that the client 200 is initially booted, and in the case that the client 200 goes down and then HD thereof is replaced with a new one and the recovery thereof is needed, the environment of the client 200 is easily and automatically restored without administrative operator manipulation from the server 100. Especially, even when a user has no technical knowledge, there is no need to perform a manual operation in the client 200. Thus, the serviceability of the system can be enhanced. Moreover, the necessity for dispatching a worker to the client 200 is eliminated. This facilitates the management of the system. Moreover, an operator at the server 100 can get hold of the status of installation in the client 200. This enhances the reliability of environment construction in the client/server system.

Next, the kinds of backup data backed up from the client 200, which are periodically acquired by and stored in the server 100 at step S1, are described hereinbelow. There are plural kinds of backup data. For example, the following three kinds of backup data are stored in HDD 105 of the server 100. It is selected by manipulating the management console 150 which of the backup data respectively corresponding to the following three options is installed to the client 200.

First Option: data obtained in the environment just before the replacement of the H thereof.

Second Option: data obtained in the environment, which includes an operating system and an application program installed at the initialization of the client.

Third Option: data obtained under the conditions that the application program is of the latest version and updated before the replacement of the HD, when the conditions of the second option are met.

It is sufficient for storing the data in the case of the first option in the server 100 as the backup data to cause the server 100 to periodically acquire data stored in the HD of the client 200.

It is sufficient for storing the data in the case of the second option in the server 100 as the backup data to cause the server 100 to store and hold the operating system and the application program installed at the initialization of the client 200.

It is sufficient for storing the data of the third option in the server 100 as the backup data to record the version of the application program every time when the application program installed to the client 200 is updated.

Further, data stored in the HD of each of plural clients 200 may be stored in the HD of the server 100 as backup data. However, in the case that the number of clients is large, the server 100 needs a mass storage HD. Thus, to economize on the capacity of such an HD, it suffices that the operating system and the application program to be used in common among plural clients 200, and the application program and the document, which are peculiar to each of the clients, are stored in the server 100 by adding tags to the operating systems, the application programs and the documents, and that when the backup data is downloaded to the target client, the server 100 refers to the tag added thereto and then downloads the operating system and the application program, which correspond to the tag.

Next, other features of the apparatus for setting the environment of a client in a client/server system of the present invention are described hereinbelow.

The server 100 keeps a log of the processing to be automatically performed on the client 200 by the server 100. Then, the log is stored in the HD of the server 100. Such log data includes data representing a time at which the downloading is started, and data representing a time at which the downloading is finished. An operator can check a history of the processing, which the server automatically performs on the client, and utilize the history for troubleshooting by referring to the log.

Furthermore, the automatic installation of the backup data from the server to the client can be performed simultaneously on a plurality of clients.

Additionally, when the HD of the client is damaged and replaced with another HD, the environment just before the replacement of the HD can be restored by periodically sending data of documents, which are newly created or updated by a client or installed to the client through a communication line and then stored in the HD thereof, from the server to the client and by storing the sent data in the HD of the server.

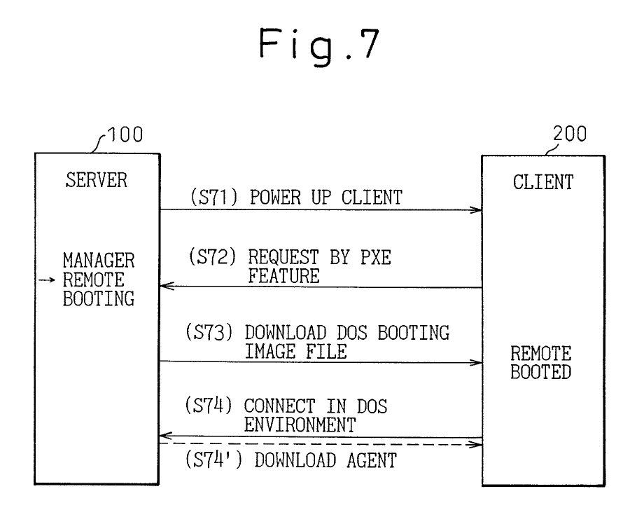

FIG. 7 is a diagram illustrating a procedure for powering up a client in the client/server system shown in FIG. 1 by manipulating the client from a server performing a WoL function.

Hereinafter, the process of powering up the client 200 from the server 100 by using the WoL function is described with reference to FIGS. 1 and 7.

At step S71, a packet is sent from the server 100 to the target client 200. Then, the client 200 is powered up by performing the WOL function.

At step S72, the PXE feature 211 is activated when the client 200 is powered up. A request from the PXE feature 211 is sent to the server 100. Then, this request is received by the manager 14.

At step S73, because the boot flag, corresponding to the client 200, which is provided in the management log file 10, is set at a remote side in a default mode, the manager 14 remote boots the client 200. Then, a DOS boot image is downloaded on to the RAM 203 of the client 200. At that time, a LAN manager is also downloaded to the client 200. This LAN manager is booted together with the DOS.

At step S74, the client 200 is connected by this LAN manager to the server 100 in the DOS environment (incidentally, the process up to this step is a remote booting process). Further, concurrently with this remote booting, at step S74′ the agent 12 is downloaded to the RAM 203 of the client 200.

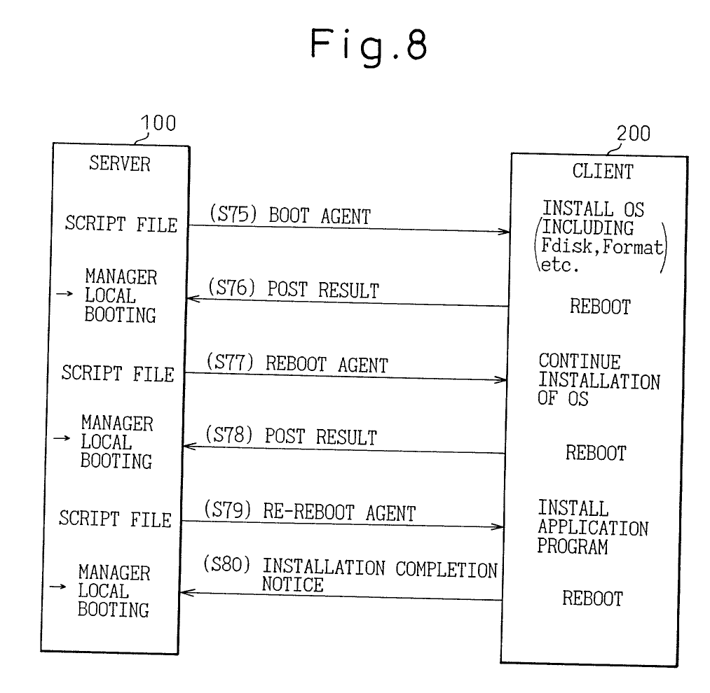

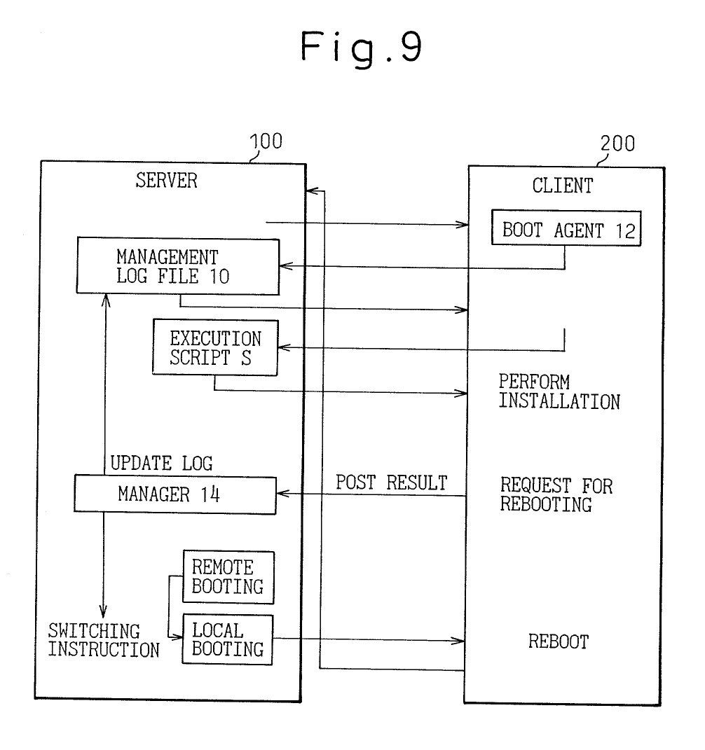

FIG. 8 is a diagram illustrating a procedure for downloading data, which is backed up from the HD of the client 200, from the server 100 to the client 200 in the client/server system shown in FIG. 1. FIG. 9 is a diagram illustrating operations of the client and the server shown in FIG. 8. Hereinafter, the processing to be performed at steps S7 and S8 illustrated in FIG. 6 is described with reference to FIGS. 1, 8, and 9.

At step S75, the agent 12 first accesses to the management log file 10 of the server 100 when booted. At that time, there is no record concerning the running status of the client 200. Subsequently, the agent 12 similarly accesses to a script file 11 of the server 100 and then executes a setup command for installing an operating system, which is set at the beginning of an execution script S thereof. At that time, first, commands, such as Fdisk and Format, included in the installed file 13 for initialization of the HDD 205 are executed. Further, script commands (for example, setup commands for setup of operating systems, such as Windows) are executed in the DOS environment. Thus, an OS install image file 13a is installed.

At step S76, a request for rebooting is made halfway through the installation of the operating system. The agent 12 posts the state of the execution to the manager 14 of the server 100. When receiving this notice, the manager 14 records the state of the execution, or updates a corresponding record. Simultaneously, the manager 14 switches the booting method from the remote booting to local booting. A boot flag provided in the management log file correspondingly to the client 200 is set at a value corresponding to the local booting.

At step S77, rebooting is performed in the client 200 according to the local booting, as a result of this switching. At that time, the agent 12 is downloaded to the client 200 again. After the rebooting, the agent 12 is booted again. Then, the agent 12 accesses to the management log file 10 again, and detects the progression state of the installation in the target client 200. Further, the agent 12 executes the rest of the execution script S of the script file 11, which is determined according to the detected state, and thus continues to perform the installation.

At step S78, the installation of the operating system to the client 200 is finished. Then, rebooting is requested again. At that time, the agent 12 posts the completion of the installation of the operating system to the manager 14 of the server 100. When receiving this notice, the manager 14 records the completion of the installation to the client 200 in the management log file 10, and updates the log file 10.

At step S79, the agent 12 is downloaded to the client 200 again upon completion of rebooting, and then booted. The agent 12 accesses to the management log file 10 again, and detects the progression state of the installation to the client 200. According to the progression state, the installation of an application program installation image file 13b defined in the rest of the execution script S of the script file 11 is performed. In the case of installing a plurality of application program installation image files 13b, although a request for rebooting is made during the installation of each of the files 13b, the agent 12 is booted in the client 200, and the agent 12 then accesses to the management log file 10 and performs the installation of the application program installation image files 13b according to the execution script of the script file 11, as in the aforementioned case of a single application installation image file 13b.

At step S80, a request for rebooting is made upon completion of installing all the application programs. Then, the agent 12 posts the completion of installation in all the clients to the server 100. The manager 14 of the server 100 receives this notice and completes the services.

The aforementioned process is performed between the server 100 and the target client 200. Thus, even in the case that there are an operating system and application software programs, which require rebooting the client during the installation, the installation of the operating system and the programs is automatically performed according to instructions from the server 100 to thereby enable the construction of the environment of the client 200 in the client/server system. Therefore, in the case that the client 200 is initially booted, and in the case that the client 200 goes down and the recovery thereof is needed, the recovery thereof is automatically performed from the manipulation from the server 100. Especially, even when a user has no technical knowledge, there is no need to perform a manual operation in the client 200. Thus, the serviceability of the system can be enhanced. Moreover, the necessity for dispatching a worker to the client 200 is eliminated. This facilitates the management of the system. Moreover, an operator positioned at the side of the server 100 can obtain the status of installation in the client 200. This enhances the reliability of environment construction in the client/server system.

Although the script file 11 is always provided in the server 100, the system may be adapted so that the script file 11 is downloaded to the client 200 before the installation or after the rebooting, and that the agent 12 performs the installation according to the execution script S provided in the client 200. In this case, the operation efficiency of the system is enhanced because the agent 12 can refer to the execution script S without accessing to the server 100.

Further, although the management log file 10 is provided in the server 100 in the case of the aforementioned embodiment, the system may be adapted so that the log file 10 is downloaded from the server 100 to and provided in the client 200, that the log file 10 is updated in the client 200 according to the execution state of the installation in the client 200, and that the log file 10 is returned to the server 100 before the client 200 is rebooted, and downloaded to the client 200 after rebooted, and thereafter updated according to the execution of the installation in the client 200. Even in such a case, the management log file 10, whose history is updated before the rebooting, is once moved to the server 100. After the rebooting, the log file 10 is downloaded to the client 200 again. Then, the agent 12 continues to perform the installation by referring to the downloaded log file 10. Thus, the installation can be performed according to the rest of the execution script S to be executed after the rebooting. This presents no particular problems.

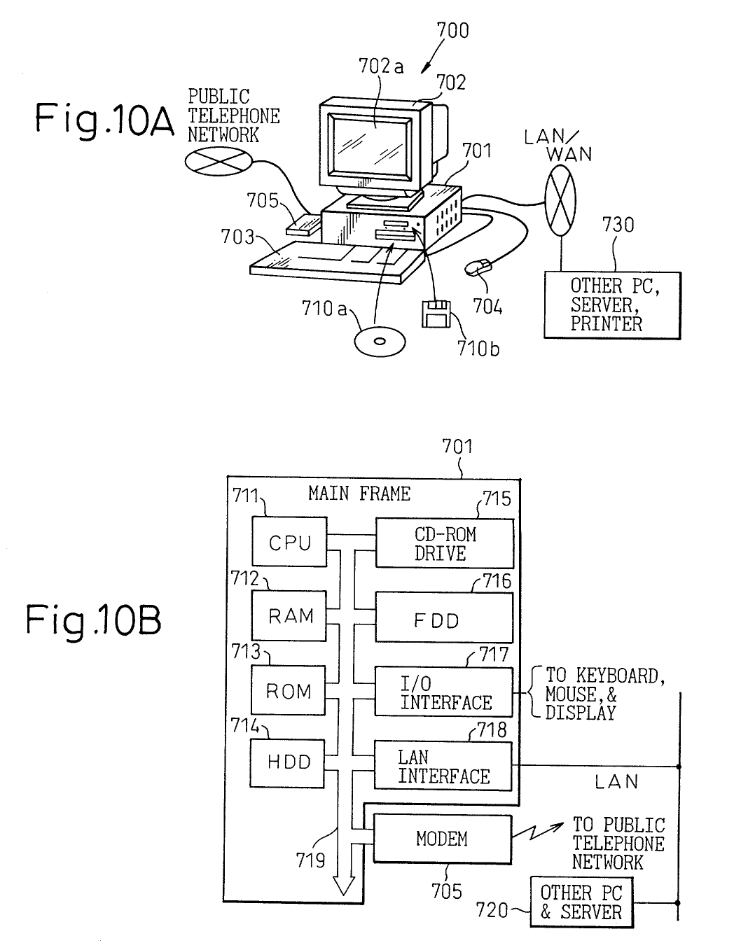

Fig. 10A is a perspective diagram showing the practical constitution of the client or the server for illustrating a method of installing a program recording medium, which is used in an apparatus for setting the environment of the client in the client/server system of the present invention, in the client or the server. Fig. 10B is a block diagram illustrating the inner constitution of the client or the server shown in FIG. 10A.

The client or server (hereunder referred to as a computer system) 700 illustrated in FIG. 10A has a main frame 701, a display unit 702 for indicating information on images on a display screen 702a according to commands from the main frame 701, a keyboard 703, through which various kinds of information is inputted to the computer system 700, a mouse 704 for specifying an arbitrary position on the display screen 702a of the display unit 702, and a modem 705 connected to a public telephone network.

As illustrated in Fig. 10B, the main frame 701 contains a CPU 711, a RAM 712, a ROM 713, a disk drive unit (that is, a hard disk drive (HDD)) 14, a CD-ROM drive 713, a flexible disk drive (FDD) 716, an I/O interface 717 connected to the display unit 702, to the keyboard 703, and to the mouse 704, and a LAN interface 18 for accessing to a database connected thereto through a communication line. These constituent elements are connected to one another through the bus 719.

Programs of the present invention stored in portable recording media, such as the CD-ROM 710a, the floppy disk (FD) 710a, a DVD disk (not shown), a magneto-optical disk, an IC card, or stored in a database connected to the computer system through the modem 705 or the LAN interface 718 are installed in the computer system 700 and executed therein. The installed programs of the present invention is stored in a hard disk (HD) inserted in the HDD 714 and executed by the CPU 711 by utilizing the RAM 712.

Incidentally, the program recording media of the present invention include a portable recording medium, such as a CD-ROM 710a, a floppy disk (FD) 710b, a DVD disk, a magneto-optical disk, and an IC card, and storage devices, such as hard disks provided in and outside the computer system 700, and a database holding programs of the present invention, which are stored in an apparatus, connected thereto through a communication line, for supplying programs to be installed, for example, a database of another computer system (PC) or a server indicated by reference numeral 720 and connected to the computer system 700 through a LAN, and a transmission medium transmitted through a communication line. The computer system 700 can be connected to another computer system (PC), a server, or a printer, which is indicated by reference numeral 730, through a local area network and/or a wide area network(LAN/WAN).

As described above, according to the present invention, there are provided an apparatus and method for setting the environment of a client in a client/server system, by which the environment of a client can be easily and automatically restored without administrative operator manipulation from the server side after the client is powered up after the replacement of the hard disk of the client or after the client is powered up from the server by utilizing a WoL feature. Further, the present invention provides a program recording medium therefor.

Although the preferred embodiments of the present invention have been described above, it should be understood that the present invention is not limited thereto and that other modifications will be apparent to those skilled in the art without departing from the sprint of the invention.

The scope of the present invention, therefore, should be determined solely by the appended claims.

What is claimed is:

1. An apparatus for setting environment of a client in a client/server system, said apparatus comprising:
a unit recognizing that replacement of a hard disk of a client is performed; and
a unit that installs data, which is backed up from said hard disk provided in said client before the replacement thereof and subsequently and preliminarily stored in a server, in response to the replacement thereof onto a hard disk provided in said client after the replacement thereof.

2. The apparatus for setting the environment of a client in a client/server system according to claim 1, wherein a plurality of kinds of data are prepared in said server as the backed-up data, wherein one of the plurality of kinds of data is selected, and wherein the selected one kind of data is then installed in said client.

3. The apparatus for setting the environment of a client in a client/server system according to claim 2, wherein the selected one kind of data is data backed up in the environment just before the replacement.

4. The apparatus for setting the environment of a client in a client/server system according to claim 2, wherein the selected one kind of data is data backed up in the environment at the time of initially setting said client.

5. The apparatus for setting the environment of a client in a client/server system according to claim 4, wherein an application program included in the data, which is backed up in the environment at the time of initially setting said client, is updated to the latest version thereof until the replacement of said hard disk.

6. The apparatus for setting the environment of a client in a client/server system according to one of claims 1 to 5, wherein said server has a unit keeping a log of processing performed on said client.

7. The apparatus for setting the environment of a client in a client/server system according to one of claims 1 to 6, wherein said client periodically sends document data to said server.

8. A method for setting the environment of a client in a client/server system, said method comprising the steps of:
recognizing that replacement of a hard disk of a client is performed; and
installing data, which is backed up from said hard disk provided in said client before the replacement thereof and subsequently and preliminarily stored in a server, in response to the replacement thereof onto a hard disk provided in said client after the replacement thereof.

9. A computer readable program recording medium for recording a program causing a computer to set the environment of a client in a client/server system, said medium recording a program causing a computer to perform the steps of:
recognizing that replacement of a hard disk of a client is performed; and
installing data, which is backed up from said hard disk provided in said client before the replacement thereof and subsequently and preliminarily stored in a server, in response to the replacement thereof onto a hard disk provided in said client after the replacement thereof.
